(19) United States
(12) Patent Application Publication
(10) Pub. No.: US 2018/0143468 A1
(43) Pub. Date: May 24, 2018

(54) OPTICAL DEVICE

(71) Applicant: PANASONIC INTELLECTUAL PROPERTY MANAGEMENT CO., LTD., Osaka (JP)

(72) Inventors: Yuko SUZUKA, Kyoto (JP); Masuyuki OTA, Osaka (JP)

(73) Assignee: PANASONIC INTELLECTUAL PROPERTY MANAGEMENT CO., LTD., Osaka (JP)

(21) Appl. No.: 15/568,704

(22) PCT Filed: May 12, 2016
(86) PCT No.: PCT/JP2016/002328

§ 371 Date: Oct. 23, 2017

(30) Foreign Application Priority Data
May 27, 2015 (JP) 2015-107679

(51) Int. Cl. G02F 1/137; G02F 1/1343; G02F 1/1335

(52) U.S. Cl. CPC G02F 1/137; G02F 1/13439; G02F 2203/50; G02F 2203/01; G02F 2001/13756; G02F 1/133504

(57) ABSTRACT

An optical device includes a first optical adjuster, a second optical adjuster, and a phase modulation layer. The optical adjuster includes: an electrode; a counter electrode; a refractive index adjustment layer that has a refractive index changing in response to an electric field, is changeable between a transparent state and a state in which the refractive index adjustment layer distributes incident light, and has refractive index anisotropy; and a textured layer that gives the refractive index adjustment layer an uneven surface. The refractive index adjustment layer is provided between the electrode and the counter electrode and contains liquid crystals. The first optical adjuster and the second optical adjuster are arranged in the thickness direction of the optical device.

### TECHNICAL FIELD

The present invention relates to optical devices, and, for example, relates to an optical device whose optical state can change with electricity.

### BACKGROUND ART

Optical devices which change their optical states when electricity is supplied thereto have been proposed. For example, Patent Literature (PTL) 1 discloses a light-adjusting element in which an electrolyte layer including an electrochromic material that contains silver is sandwiched between a pair of transparent electrodes and depressions and protrusions of nanometer-scale order are provided in one of the transparent electrodes. The light-adjusting element in PTL 1 can form a mirror state through application of a voltage.

### CITATION LIST

### Patent Literature

PTL 1: International Publication No. 2012/118188

### SUMMARY OF THE INVENTION

### Technical Problem

The light-adjusting element in the aforementioned PTL 1 can form a mirror state, but is not configured to change the direction of travel of light to a desired direction.

The present disclosure aims to provide an optical device capable of distributing light.

### Solution to Problem

An optical device is disclosed. The optical device includes: a first optical adjuster; a second optical adjuster, and a phase modulation layer provided between the first optical adjuster and the second optical adjuster. The first optical adjuster includes: a first electrode that is light-transmissive; a first counter electrode that is light-transmissive; a first refractive index adjustment layer that has a refractive index changing in response to an electric field, and is changeable between a transparent state and a state in which the first refractive index adjustment layer distributes incident light, and has refractive index anisotropy; and a first textured layer that gives the first refractive index adjustment layer an uneven surface. The first counter electrode is electrically paired with the first electrode. The first refractive index adjustment layer is provided between the first electrode and the first counter electrode and contains liquid crystals. The second optical adjuster includes: a second electrode that is light-transmissive; a second counter electrode that is light-transmissive; a second refractive index adjustment layer that has a refractive index changing in response to an electric field, is changeable between the transparent state and a state in which the second refractive index adjustment layer distributes incident light, and has refractive index anisotropy; and a second textured layer that gives the second refractive index adjustment layer an uneven surface. The second counter electrode is electrically paired with the second electrode. The second refractive index adjustment layer is provided between the second electrode and the second counter electrode and contains liquid crystals. The first optical adjuster and the second optical adjuster are arranged in the thickness direction of the optical device.

### Advantageous Effect of Invention

According to the present disclosure, it is possible to provide an optical device capable of distributing light.

### BRIEF DESCRIPTION OF DRAWINGS

FIG. 1 is a cross-sectional view schematically illustrating an example of an optical device according to an embodiment.

FIG. 2 is a cross-sectional view schematically illustrating an example of an optical device according to an embodiment.

FIG. 3 illustrates an example of light distribution performed by an optical device according to an embodiment.

FIG. 4 illustrates an example of the passage of light through an optical device according to an embodiment.

### DESCRIPTION OF EXEMPLARY EMBODIMENT

Hereinafter, an optical device according to an embodiment of the present invention will be described in detail with reference to the drawings. Note that the embodiment described below shows a specific preferred example of the present invention. Thus, the numerical values, shapes, materials, structural elements, and the arrangement and connection of the structural elements, steps, the processing order of the steps, etc., shown in the following embodiment are mere examples, and are not intended to limit the present invention. Accordingly, among the structural elements in the following embodiment, structural elements not recited in an independent claim indicating the broadest concept of the present invention are described as arbitrary structural elements.

The figures are schematic diagrams and are not necessarily precise illustrations. Therefore, for example, scale reduction, etc., in the figures are not necessarily the same.

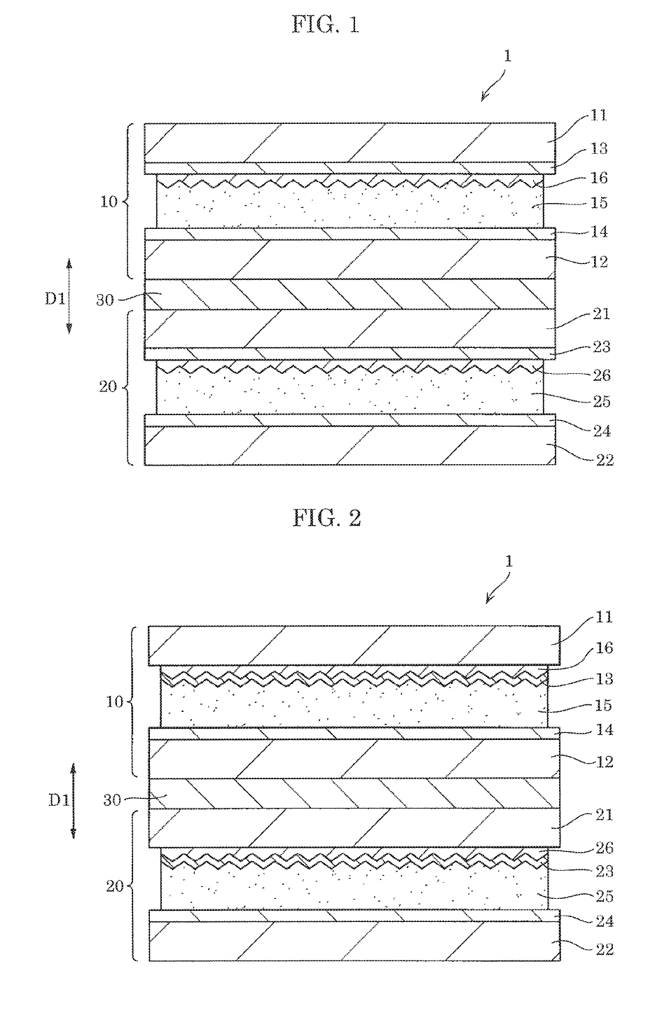

FIG. 1 illustrates an example of an optical device (optical device 1). In FIG. 1, a layer structure of optical device 1 is schematically illustrated, and the actual size, etc., of each portion of optical device 1 is not limited to that in the illustration. Optical device 1 can be formed into a panel shape.

Optical device 1 includes first optical adjuster 10 and second optical adjuster 20. First optical adjuster 10 includes: first electrode 13; first counter electrode 14 electrically paired with first electrode 13; first refractive index adjustment layer 15 provided between first electrode 13 and first counter electrode 14; and first textured layer 16 which gives first refractive index adjustment layer 15 an uneven surface. First electrode 13 and first counter electrode 14 are light-transmissive. First refractive index adjustment layer 15 contains liquid crystals and has a refractive index changing in response to an electric field, and is changeable between a transparent state and a state in which first refractive index adjustment layer 15 distributes incident light. Second optical adjuster 20 includes: second electrode 23; second counter electrode 24 electrically paired with second electrode 23; second refractive index adjustment layer 25 provided between second electrode 23 and second counter electrode 24; and second textured layer 26 that gives second refractive index adjustment layer 25 an uneven surface. Second electrode 23 and second counter electrode 24 are light-transmissive. Second refractive index adjustment layer 25 contains liquid crystals and has a refractive index changing in response to an electric field, and is changeable between the transparent state and a state in which second refractive index adjustment layer 25 distributes incident light. First optical adjuster 10 and second optical adjuster 20 are arranged in the thickness direction of optical device 1.

Optical device 1 can create a transparent state and a light distribution state according to a change in the refractive index of first refractive index adjustment layer 15 and second refractive index adjustment layer 25. Here, as a result of the two refractive index adjustment layers being arranged in the thickness direction, it is possible to efficiently distribute light having different directions of vibration. Specifically, light (especially, natural light) may contain components having different directions of vibration, and when there is a single refractive index adjustment layer, a component of the light having one direction of vibration may be distributed while a component of the light having a direction of vibration orthogonal to the one direction may not be distributed. When there are two refractive index adjustment layers, however, both the components of the light having different two directions of vibration can be distributed. Thus, there is a significant difference in the variation of light between the transparent state and the light distribution state. Thus, optical device 1 can create the transparent state and the light distribution state, therefore having good optical properties.

Herein, “the thickness direction” means the thickness direction of optical device 1 unless otherwise noted. In FIG. 1, the thickness direction is indicated by D1. The thickness direction may be a direction perpendicular to a surface of first substrate 11. The thickness direction includes a stacking direction. The thickness direction includes a direction from first electrode 13 toward first counter electrode 14 and a direction from first counter electrode 14 toward first electrode 13. In FIG. 1, the layers of optical device 1 can be considered to spread laterally and also spread perpendicularly to the plane defined by the sheet of the drawing. The wording “plan view” means a view seen along the direction (thickness direction D1) perpendicular to the surface of the substrate 11.

First optical adjuster 10 further includes first substrate 11 and first counter substrate 12. A layered structure of first electrode 13, first textured layer 16, first refractive index adjustment layer 15, and first counter electrode 14 is provided between first substrate 11 and first counter substrate 12 which support this layered structure. Furthermore, first substrate 11 and first counter substrate 12 protect this layered structure. Moreover, one of first substrate 11 and first counter substrate 12 can function as a base substrate on which the layered structure is formed, and the other can function as a cover substrate which covers the layered structure.

Second optical adjuster 20 further includes second substrate 21 and second counter substrate 22. A layered structure of second electrode 23, second textured layer 26, second refractive index adjustment layer 25, and second counter electrode 24 is provided between second substrate 21 and second counter substrate 22 which support this layered structure. Furthermore, second substrate 21 and second counter substrate 22 protect this layered structure. Moreover, one of second substrate 21 and second counter substrate 22 can function as a base substrate on which the layered structure is formed, and the other can function as a cover substrate which covers the layered structure.

Optical device 1 in FIG. 1 further includes phase modulation layer 30 between first optical adjuster 10 and second optical adjuster 20. Phase modulation layer 30 has a function of changing the phase of incident light. First refractive index adjustment layer 15 has refractive index anisotropy. Second refractive index adjustment layer 25 has refractive index anisotropy. When there is phase modulation layer 30, the modulation of the phase of light causes a change in the direction of vibration of the light, and thus light having different directions of vibration can be more easily distributed by the two optical adjusters. Accordingly, components of light having different directions of vibration can be efficiently distributed. Here, first refractive index adjustment layer 15 and second refractive index adjustment layer 25 may have the same refractive index anisotropy. This makes it easy to form the refractive index adjustment layer and allows light having different directions of vibration to be effectively distributed through the modulation of the phase of the light. In particular, phase modulation layer 30 may shift the phase of incident light having wavelength λ by (½)λ. In this case, the light can be more efficiently distributed. Herein, the refractive index anisotropy means that the refractive index varies depending on direction. For example, when the refractive index adjustment layer has refractive index anisotropy, the refractive index of the refractive index adjustment layer may be different between thickness direction D1 and a direction perpendicular to thickness direction D1. A detailed mechanism of the distribution of light will be described later.

First textured layer 16 and second textured layer 26 may be identical in structure. In this case, since these can be formed by the same method, manufacturing becomes easy, and reducing cost becomes possible. First textured layer 16 and second textured layer 26 may be formed using the same material. First textured layer 16 and second textured layer 26 may have the same uneven surface. First textured layer 16 and second textured layer 26 may have the same thickness.

First optical adjuster 10 and second optical adjuster 20 may be identical in structure. In this case, since these can be formed by the same method, manufacturing becomes easy, and reducing cost becomes possible. First optical adjuster 10 and second optical adjuster 20 may be formed using the same material. First optical adjuster 10 and second optical adjuster 20 may have the same textured layer. In the case where the two optical adjusters are identical in structure, a plurality of optical adjusters may be prepared, and one of them may be used as first optical adjuster 10, and a different one of them may be used as second optical adjuster 20, for example.

In each of first optical adjuster 10 and second optical adjuster 20 of optical device 1 in FIG. 1, the electrode, the textured layer, the refractive index adjustment layer, and the counter electrode are provided in this order between the substrate and the counter substrate. These layers are arranged in the thickness direction. The optical adjuster has a layered structure in which the substrate, the electrode, the textured layer, the refractive index adjustment layer, the counter electrode, and the counter substrate are combined. The optical adjuster is embedded in optical device 1. Optical device 1 in FIG. 1 includes two optical adjusters.

Optical device 1 allows the passage of light. Optical device 1 may be a window. When optical device 1 is fitted onto an exterior wall of a building, outside light is allowed to enter the inside of the building. First substrate 11 may be positioned on the outdoor side. Second counter substrate 22 may be positioned on the indoor side. Naturally, second counter substrate 22 may be positioned on the outdoor side and first substrate 11 may be positioned on the indoor side. Optical device 1 may be fitted onto a part other than the exterior wall. For example, optical device 1 may be fitted onto an interior wall, a partition, or the like. Optical device 1 may be fitted as an on-vehicle window. First substrate 11 is defined as a substrate on the side on which light enters.

The pairs of electrodes in the optical adjusters (the pair of first electrode 13 and first counter electrode 14 and the pair of second electrode 23 and second counter electrode 24) are configured to be able to apply an electric field to the refractive index adjustment layers. One of the electrodes in the pair functions as an anode, and the other functions as a cathode. The refractive index of the refractive index adjustment layer changes through application of a voltage by the pair of electrodes. The pair of electrodes function as electrodes for driving optical device 1. The electrodes are in the form of layers.

Optical device 1 includes a plurality of electrodes including first electrode 13, first counter electrode 14, second electrode 23, and second counter electrode 24. The plurality of electrodes (first electrode 13, first counter electrode 14, second electrode 23, and second counter electrode 24) may each be configured of, for example, a transparent conductive layer. Transparent metal oxide, conductive particle-containing resin, a thin metal film, or the like can be used as a material of the transparent conductive layer. One example of the material of the electrode that is light-transmissive is transparent metal oxide such as indium tin oxide (ITO) or indium zinc oxide (IZO). An electrode including transparent metal oxide can be used as an electrode of optical device 1. The electrode may be a layer containing a silver nanowire or a metal-containing transparent layer such as a thin silver film. Alternatively, the electrode may be a stacked structure including a transparent metal oxide layer and a metal layer. Alternatively, the electrode may be formed by providing an auxiliary line on a transparent conductive layer. The electrode may have the effect of shielding heat. With this, the thermal insulation properties can improve.

The electrode may contain metal. Metal can reduce the resistance of the electrode. With metal, an electric current becomes more likely to flow evenly in a plane of optical device 1, and thus in-plane distribution of optical properties may improve. However, when a large amount of metal is contained, the light-transmitting properties of the electrode may be reduced, and therefore metal is contained in an amount that does not cause adverse effects on the light-transmitting properties of the electrode. For example, metal may be contained in the form of a metal nanowire, a metal auxiliary line or a thin metal film in the electrode. The metal nanowire may be dispersed in the transparent conductive layer. In this case, the electrode is formed of a transparent conductive layer containing a metal nanowire. The metal auxiliary line may be provided above the transparent conductive layer, in contact therewith. In this case, the electrode includes the transparent conductive layer and the auxiliary line. The thin metal film may be provided on a surface of the transparent conductive layer. In this case, the electrode includes the transparent conductive layer and the thin metal film. Among the plurality of electrodes, any one to three electrodes may contain metal, or all of them may contain metal. All of the plurality of electrodes may contain metal. At least one of the plurality of electrodes may be split in plan view. This enables partial control of optical device 1. In this case, when the plurality of electrodes are split in plan view, resulting electrodes may have the same shape.

The electrode may be configured to be able to electrically connect to a power supply. In order to connect to the power supply, optical device 1 may include an electrode pad and an electrical connection portion in which electrode pads are electrically collected, for example. The electrical connection portion may be configured of a plug or the like. These electrodes may be connected to the power supply through lines. The power supply may be an external power supply or may be an internal power supply. In optical device 1 in FIG. 1, each of the electrodes has a part extending beyond the textured layer in plan view, and this part can be used for connection with the power supply. Thus, power is easily supplied to optical device 1.

Optical device 1 includes a plurality of substrates including first substrate 11, first counter substrate 12, second substrate 21, and second counter substrate 22. First counter substrate 12 is paired with first substrate 11. Second counter substrate 22 is paired with second substrate 21. The plurality of substrates are light-transmissive. These plural substrates (first substrate 11, first counter substrate 12, second substrate 21, and second counter substrate 22) may be bonded together at end portions. An adhesive may be used in the bonding. The adhesive may be solidified. The adhesive may form a spacer. The spacer may define the thickness of the gap between these substrates. The spacer may protect end portions of the refractive index adjustment layer and phase modulation layer.

The plurality of substrates described above may be configured using the same substrate material or may be configured using different substrate materials, but are preferably configured using the same substrate material. Examples of the substrate material include a glass substrate and a resin substrate. Examples of the material of the glass substrate include soda glass, alkali-free glass, and high refractive index glass. Examples of the material of the resin substrate include polyethylene terephthalate (PET) and polyethylene naphthalate (PEN). The glass substrate has the advantages of high transparency. The glass substrate has the advantages of high moisture-proof properties. The resin substrate has the advantage of being less scattered upon breakage. A flexible substrate may be used. The flexible substrate can be bent. The flexible substrate offers excellent handleability. The flexible substrate can be easily formed using a resin substrate or thin glass. The substrates described above may have the same thickness or may have different thicknesses. From the perspective of reducing the number of materials, it is preferred that these have the same thickness.

In the visible light range, the difference in refractive index between the plurality of substrates described above is smaller than a predetermined value. This enables effective passage of light. For example, the difference in refractive index between the plurality of substrates is preferably 0.2 or less and more preferably 0.1 or less. The plurality of substrates described above may have the same refractive index.

Furthermore, the difference in refractive index between the substrate and the electrode that are provided adjacent to each other is smaller than a predetermined value. This allows light to effectively pass through the interface therebetween. For example, in the visible light range, the difference in refractive index between the substrate and the electrode that are provided adjacent to each other is preferably 0.2 or less and more preferably 0.1 or less. The pair of electrodes may have approximately the same refractive index. For example, the difference in refractive index between the pair of electrodes may be 0.1 or less.

The refractive index of the plurality of substrates may be in the range from 1.3 to 2.0, for example, but is not limited to this range. The refractive index of the plurality of electrodes may be in the range from 1.3 to 2.0, for example, but is not limited to this range.

The textured layer of the optical adjuster is provided between the refractive index adjustment layer and the electrode on the light entry side among the pair of electrodes. Specifically, first textured layer 16 is provided between first electrode 13 and first refractive index adjustment layer 15. Second textured layer 26 is provided between second electrode 23 and second refractive index adjustment layer 25. The textured layer is in contact with the electrode on the light entry side. The textured layer is in contact with the refractive index adjustment layer. The textured layer has a textured surface. The textured layer is in the form of a film. In the present disclosure, the film means an integrally spread element having a planar shape. Note that the film may be segmented at an appropriate point. The textured layer is continuous in a planar pattern. The textured layer includes no segmented region at least within a predetermined region that can be called a film (for example, a 1 cm by 1 cm region). The textured layer may be formed so as to separate layers adjacent to each other in the thickness direction. The textured layer may cover an adjacent layer (the electrode on the light entry side and/or the refractive index adjustment layer).

In the example in FIG. 1, the textured layer (first textured layer 16 or second textured layer 26) has a flat surface facing the electrode on the light entry side and a textured surface facing the refractive index adjustment layer. The textured layer includes at least one of (i) a plurality of protrusions and (ii) a plurality of recesses, and the textured surface is formed of these protrusions and/or recesses. The textured surface may be structured so that the plurality of protrusions protrude from the flat surface or may be structured so that the plurality of recesses are depressed from the flat surface or may be structured so that the plurality of protrusions and the plurality of recesses are arranged from end to end to leave no flat surface.

In the textured layer (first textured layer 16 or second textured layer 26) illustrated in FIG. 1, the protrusion protrudes toward the refractive index adjustment layer. The plurality of protrusions may be regularly arranged or may be irregularly arranged. The plurality of protrusions may be periodically arranged. The plurality of protrusions may be arranged at equal intervals. The plurality of protrusions may be randomly arranged. The recess is depressed toward the electrode on the light entry side. The plurality of recesses may be regularly arranged or may be irregularly arranged. The plurality of recesses may be periodically arranged. The plurality of recesses may be arranged at equal intervals. The plurality of recesses may be randomly arranged. In the case where optical device 1 is installed as a window, the textured structure may be different between an upper part and a lower part of the window so that light can be appropriately distributed in each of the upper part and the lower part.

The protrusions and recesses of the textured layer (first textured layer 16 or second textured layer 26) may be formed so that the intensity of distributed light is high in a specific direction. For example, the protrusions and recesses are formed so that light incident on optical device 1 is more likely to travel in a specific oblique direction instead of spreading overall. This makes it possible to cause light passing through optical device 1 to have different intensity according to the position. Such configuration is advantageous when optical device 1 is used as a window. The distribution of light can be controlled according to the shape, arrangement, etc., of the protrusions and/or the recesses. For example, the plurality of protrusions and the plurality of recesses may be different in shape or in ratio of presence in the plane.

The distribution of light by optical device 1 can be evaluated in the method below. Light having a wavelength of 400 nm to 800 nm is caused to enter optical device 1 in the direction from first substrate 11 to second counter substrate 22 as incident light. The direction of transmitted light is evaluated on the second counter substrate 22 side. When the intensity of the light that has passed through optical device 1 is high in a specific direction at an angle different from the angle of the incident light, optical device 1 is regarded as being in the light distribution state. The direction of the light may be perpendicular to optical device 1. Sunlight may be incident not only in the perpendicular direction, but also in an oblique direction, and therefore, when sunlight is incident in the oblique direction in the same or similar process and the intensity of transmitted light is high in a specific direction at an angle different from the angle of the incident light, optical device 1 is regarded as being in the light distribution state.

The protrusion size (equal to the recess size) of the textured layer is defined as a protrusion height. The protrusion height is, for example, in the range from 100 nm to 100 μm, but is not limited to this range. The protrusion height is the length from the bottom of the recess to the tip of the protrusion in the thickness direction. The distance between a protrusion and another protrusion adjacent to that protrusion is, for example, in the range from 100 nm to 100 μm, but is not limited to this range. The distance between a recess and another recess adjacent to that recess is, for example, in the range from 100 nm to 100 μm, but is not limited to this range. The distance between a protrusion and another protrusion adjacent to that protrusion is defined as a pitch of the protrusions and the recesses. The pitch of the protrusions and the recesses based on the recesses is defined likewise. Light control tends to be good when microscale protrusions and recesses are provided. The protrusions and recesses of the textured layer may be formed, for example, by imprinting. Light control tends to be good when the protrusion-recess pitch is smaller than the protrusion height. When the protrusion-recess pitch is smaller than the protrusion height, however, time is needed for production in other protrusion and recess production processes such as photolithography, meaning that such production is difficult. In the case where imprinting is used to produce protrusions and recesses, protrusions and recesses with the protrusion-recess pitch smaller than the protrusion height can be easily produced. The average of protrusion-recess pitches can be regarded as an average protrusion-recess cycle.

The textured layer has an elongated shape orthogonally with respect to direction D1 and the thickness direction, for example. The protrusion of the textured layer, for example, extends orthogonally with respect to direction D1 and the thickness direction while maintaining its triangular cross-section. Thus, the textured layer has a pattern of stripes in plan view.

The textured layer is light-transmissive. The difference in refractive index between the textured layer and the electrode in contact with the textured layer is smaller than a predetermined value. This allows light to effectively pass through the interface therebetween. For example, the difference in refractive index between the textured layer and the electrode is preferably 0.2 or less and more preferably 0.1 or less. The refractive index of the textured layer may be in the range from 1.3 to 2.0, for example, but is not limited to this range.

The textured layer may be electrically conductive. With this, the flow of electric current between the pair of electrodes can be improved. The textured layer may be formed using a material that is used for the electrode. The textured layer and the electrode in contact with the textured layer may be integrated using the same material. The textured surface, however, can be easily formed when the electrode and the textured layer are separate bodies. The textured layer may be formed using a material that allows the protrusions and the recesses to be easily formed. The textured layer may be formed using a material containing resin, for example. Examples of the resin material of the textured layer include conductive macromolecules and a conductor-containing resin. Examples of the conductive macromolecules include poly(3,4-ethylenedioxythiophene) (PEDOT). Examples of the conductor include a metal nanowire such as an Ag nanowire. The metal nanowire may be mixed with resin such as cellulose or acrylic. In the case where a mixture material containing the metal nanowire and the resin is used, it is possible to adjust the refractive index of the textured layer by the resin, and thus the transparency improves. Note that when it is possible to apply a voltage, the textured layer may be formed using an insulating material. In this case, the textured layer may be formed using resin such as acrylic and polyimide or an inorganic layer. Even in the case where the textured layer is an insulating layer, it is possible to apply a voltage between the pair of electrodes by increasing the difference in voltage between the pair of electrodes. The thickness of the insulating layer that is the textured layer may be small in order to efficiently apply a voltage. For example, the thinnest part of the textured layer formed using an insulating material is 10 μm or less.

The refractive index adjustment layer (first refractive index adjustment layer 15 or second refractive index adjustment layer 25) has a textured surface. The textured surface of the refractive index adjustment layer is formed by the textured surface of the textured layer (first textured layer 16 or second textured layer 26). The refractive index adjustment layer is in contact with the textured layer. A surface of the refractive index adjustment layer that faces the textured layer is the uneven surface. The textured surface of the refractive index adjustment layer may be formed using the protrusions and recesses of the textured layer as a die. The refractive index adjustment layer includes at least one of (i) a plurality of protrusions and (ii) a plurality of recesses. The protrusions of the refractive index adjustment layer correspond to the recesses of the textured layer. The recesses of the refractive index adjustment layer correspond to the protrusions of the textured layer. The interface between the refractive index adjustment layer and the textured layer is a textured interface.

The textured interface may be configured so that light can be easily distributed. For example, the structure of the textured interface may be a microlens structure, a Fresnel lens structure, a protruding structure, a trapezoidal structure, or the like. With the Fresnel lens structure, the shape of the textured interface may be that obtained by dividing a lens shape into a plurality of sections. Accordingly, the intensity of light is easily increased in a specific direction by the textured interface like a lens. The textured interface may be of a saw-tooth cross-section. The trapezoidal structure mentioned above includes a plurality of protrusions each having a trapezoidal cross-section. In the trapezoidal structure, the plurality of protrusions each having a trapezoidal cross-section are elongated in parallel with each other. The structure of the textured interface may be a quarter dome lens structure. These structures may be combined.

The refractive index adjustment layer (first refractive index adjustment layer 15 or second refractive index adjustment layer 25) contains liquid crystals. Liquid crystals may serve as a material having a refractive index that changes by power. Examples of the liquid crystals include nematic liquid crystals, cholesteric liquid crystals, and ferroelectric liquid crystals. The molecular orientation of liquid crystals may change when the electric field changes. This allows a change in the refractive index.

The refractive index adjustment layer may contain macromolecules. In the case where the refractive index adjustment layer contains macromolecules, the scattering of the material of the refractive index adjustment layer and the material of the substrates can be limited even when optical device 1 is broken. This improves the safety. Macromolecules stabilize changes in the refractive index of the refractive index adjustment layer. Thus, the light distribution properties are stabilized.

The refractive index adjustment layer may have a polymer structure formed using macromolecules. The polymer structure may be formed of a cross-linked structure of macromolecular chains. The polymer structure may be formed of entangled macromolecules. The polymer structure may have a mesh structure. As a result of providing liquid crystals between the meshes of the polymer structure, it is possible to adjust the refractive index. The macromolecules can provide the light scattering properties to the refractive index adjustment layer. Note that in order to improve the light distribution properties, the occurrence of macromolecules contacting the textured layer may be minimized.

As the material of the refractive index adjustment layer that contains macromolecules, polymer dispersed liquid crystals may be used. Since liquid crystals are held by macromolecules in the polymer dispersed liquid crystals, a stable refractive index adjustment layer can be formed using the polymer dispersed liquid crystals. The polymer dispersed liquid crystals are called PDLC. Furthermore, polymer network liquid crystals may be used as the material of the refractive index adjustment layer that contains macromolecules. The polymer network liquid crystals are called PNLC.

The polymer dispersed liquid crystals and the polymer network liquid crystals may include a resin portion and a liquid crystal portion. The resin portion is formed using macromolecules. The resin portion may be light-transmissive. This facilitates the passage of light through the refractive index adjustment layer. The resin portion may be formed using a thermosetting resin, an ultraviolet curable resin, or the like. The liquid crystal portion is a portion having a liquid crystal structure that changes in response to the electric field. As the liquid crystal portion, nematic liquid crystals or the like are used. The polymer dispersed liquid crystals and the polymer network liquid crystals may have a structure in which the resin portion is dotted with the liquid crystal portion. The polymer dispersed liquid crystals and the polymer network liquid crystals may have a sea-island structure in which the resin portion is the sea and the liquid crystal portion is the island. As the shape of the polymer dispersed liquid crystals and the polymer network liquid crystals, the liquid crystal portion may be connected in an irregular, mesh pattern in the resin portion. Naturally, the polymer dispersed liquid crystals and the polymer network liquid crystals may have a structure in which the liquid crystal portion is dotted with the resin portion or that the resin portion is connected in an irregular, mesh pattern in the liquid crystal portion, for example.

In the case where the refractive index adjustment layer contains macromolecules, the refractive index adjustment layer has increased retaining properties. The material of the refractive index adjustment layer is less likely to flow therein. The refractive index adjustment layer may be highly maintained with an adjusted refractive index.

The refractive index of the refractive index adjustment layer in the visible light range is adjustable to (i) a refractive index close to the refractive index of the textured layer and (ii) a refractive index significantly different from the refractive index of the textured layer, for example. This makes it possible to increase the difference between the light distribution state and the transparent state. In the state in which the refractive index of the refractive index adjustment layer is close to the refractive index of the textured layer, the difference in refractive index between the refractive index adjustment layer and the textured layer is preferably 0.2 or less and more preferably 0.1 or less. In the state in which the refractive index of the refractive index adjustment layer is significantly different from the refractive index of the textured layer, the difference in refractive index between the refractive index adjustment layer and the textured layer is preferably more than 0.1 and more preferably 0.2 or more. Note that in the present disclosure, the refractive index means the refractive index in thickness direction D1 unless otherwise noted.

In one implementation of the refractive index adjustment layer, the refractive index of the refractive index adjustment layer approaches the refractive index of the textured layer when a voltage is applied, and the difference in refractive index between the refractive index adjustment layer and the textured layer increases when no voltage is applied. The refractive index adjustment layer may be placed into the non-light distribution state (the transparent state) when the difference in refractive index between the refractive index adjustment layer and the textured layer is small and may be placed into the light distribution state when the difference in refractive index between the refractive index adjustment layer and the textured layer is large. In another implementation of the refractive index adjustment layer, the refractive index adjustment layer is placed into the light distribution state as a result of an increase in the difference in refractive index between the refractive index adjustment layer and the textured layer when a voltage is applied, and the refractive index adjustment layer is placed into the non-light distribution state (the transparent state) as a result of the refractive index of the refractive index adjustment layer approaching the refractive index of the textured layer when no voltage is applied.

As the material of the refractive index adjustment layer, a liquid crystal material having refractive index anisotropy may be used. In the case where a liquid crystal material having refractive index anisotropy is used as the refractive index adjustment layer, when an electric field is applied so that liquid crystal molecules are perpendicularly oriented, the refractive index adjustment layer is less likely to have anisotropy that is due to polarized outside light. Thus, the transparency in the transparent state improves. In order to improve the transparency, the difference between the refractive index of the perpendicularly oriented liquid crystals and the refractive index of the textured layer may be reduced.

As the material of the refractive index adjustment layer, a liquid crystal material having negative dielectric constant anisotropy is preferable. With this, the refractive index adjustment layer is placed into the light distribution state when a voltage is applied, and is placed into the non-light distribution state (the transparent state) when no voltage is applied. In the case where the light distribution state is necessary for a short period of time, the use of a liquid crystal material having negative dielectric constant anisotropy is better suited to improve the power efficiency.

The refractive index of the refractive index adjustment layer may be smaller than the refractive index of the textured layer when the difference in refractive index between the refractive index adjustment layer and the textured layer is large. With this, the direction of travel of light can be easily changed. The refractive index of the refractive index adjustment layer may be larger than the refractive index of the textured layer when the difference in refractive index between the refractive index adjustment layer and the textured layer is large. With this, the direction of travel of light can be easily changed. How the refractive index of the refractive index adjustment layer changes may be set according to a target light distribution.

The refractive index adjustment layer may be supplied with power from an alternating-current power supply or may be supplied with power from a direct-current power supply. The refractive index adjustment layer is preferably supplied with power from an alternating-current power supply. With many of the materials having a refractive index that changes in response to an electric field, the state at the time of application of a voltage cannot be maintained after time has passed since the start of the application of the voltage. An alternating-current power supply is capable of alternately applying voltages in opposite directions and thus is capable of substantially continuing to apply a voltage by changing the direction of the voltage. The waveform of the alternating current is, for example, a rectangular wave. With this, a constant voltage is likely to be applied, and thus the state after the refractive index changes can be more likely to be stabilized. The alternating current may be a pulse. The waveform of the alternating-current power supply may be a sine wave. In the case of the sine wave, power supplied from the power supply can be used as it is without modulation.

The state of the refractive index adjustment layer when a voltage is applied may be maintained. This means that a voltage is applied when the refractive index needs to change, but it is not necessary to apply a voltage when the refractive index does not need to change, and thus the power efficiency improves. The properties of maintaining a refractive index without changes are called hysteresis. These properties may be called storage properties (memory properties). The hysteresis may be seen as a result of application of a voltage equal to or higher than a predetermined voltage. The longer the period of time in which the refractive index is maintained, the better; for example, 10 minutes or more is preferable, 30 minutes or more is more preferable, one hour or more is still more preferable, 12 hours or more is yet more preferable, and 24 hours or more is far more preferable.

Phase modulation layer 30 can change the phase of light. When light having one direction of vibration passes through phase modulation layer 30, the direction of vibration of the light changes. Phase modulation layer 30 is provided between first optical adjuster 10 and second optical adjuster 20. As illustrated in FIG. 1, in the present embodiment, phase modulation layer 30 is provided between first counter substrate 12 and second substrate 21. Optical device 1 can effectively distribute light by having phase modulation layer 30 provided between the two optical adjusters.

Phase modulation layer 30 may be formed using an appropriate material that changes the phase of light. Examples of the material of phase modulation layer 30 include polycarbonate, a cycloolefin resin, and a liquid-crystal polymer (LCP). Phase modulation layer 30 may be shaped by uniaxially or biaxially stretching the resins. Phase modulation layer 30 may be formed by solidifying a fluid material or may be formed by attaching a formed body (for example, a phase modulation sheet). Furthermore, phase modulation layer 30 may have adhesiveness. This eliminates the need to add an adhesive because phase modulation layer 30 exhibits self-adhesiveness.

Optical device 1 can be formed, for example, by forming a plurality of optical adjusters and bonding two of them with phase modulation layer 30 interposed therebetween. The optical adjuster may be formed by arranging the substrate having the electrode and the textured layer thereon and the counter substrate having the counter electrode thereon so as to face each other and injecting the fluid material of the refractive index adjustment layer into the space between the substrate and the counter substrate. The plurality of substrates may be bonded with an adhesive material provided on the outer edges.

FIG. 2 illustrates another example of optical device 1. Elements that are the same as those in the embodiment in FIG. 1 share the same reference marks, and as such, explanations thereof are omitted.

Optical device 1 in FIG. 2 is different from that in FIG. 1 in the arrangement of the textured layer and the electrode on the light entry side in first optical adjuster 10 and second optical adjuster 20. In the example in FIG. 2, the textured layer, one of the electrodes, the refractive index adjustment layer, and the other of the electrodes are arranged in this order along a direction of travel of light. Other than that, this example may be the same as the embodiment in FIG. 1.

In the example in FIG. 2, the electrode (first electrode 13 or second electrode 23) is provided between the textured layer (first textured layer 16 or second textured layer 26) and the refractive index adjustment layer (first refractive index adjustment layer 15 or second refractive index adjustment layer 25). The textured layer is provided between the substrate and the electrode. The electrode adjacent to the textured layer has a textured surface. The shape of this electrode follows the shape of the textured layer, and a surface of the electrode that faces the refractive index adjustment layer is the textured surface. The textured layer is in the form of a film and gives the refractive index adjustment layer an uneven surface in optical device 1 in FIG. 2 as well. However, the uneven surface is provided to the refractive index adjustment layer via the electrode.

The shape of the textured layer (first textured layer 16 or second textured layer 26) can be the same as or similar to that described with reference to FIG. 1; the above description can apply to the shape of the textured layer. For example, the textured layer may include at least one of (i) a plurality of protrusions and (ii) a plurality of recesses. In the case, the protrusions protrude toward the electrode, and the recesses are depressed toward the substrate. The interface between the refractive index adjustment layer and the electrode is a textured interface. The structure of the textured interface can be the same as or similar to the structure described above. A preferred implementation of the textured layer illustrated in FIG. 2 is described using different names of layers that appropriately depend on the position of each layer with reference to the textured layer described in the example in FIG. 1.

In the example in FIG. 2, the textured layer (first textured layer 16 or second textured layer 26) may be electrically conductive or may be electrically non-conductive. Since the electrode having protrusions and recesses and the refractive index adjustment layer are in contact with each other, power can be supplied even when the textured layer is electrically non-conductive. In the case where the textured layer is electrically conductive, the textured layer can supplement the electrical conductivity of the electrode. The textured layer may be formed using a material that allows the protrusions and the recesses to be easily formed. The textured layer may be formed using a material containing resin, for example.

A textured interface is provided between the textured layer and the electrode adjacent to the textured layer. The electrode adjacent to the textured layer has opposite uneven surfaces. The surface of this electrode that faces the refractive index adjustment layer is a textured surface. This electrode may be stacked on a surface of the textured layer. As a result of the electrode being formed on the textured layer, the textured surfaces of the electrode are formed.

The refractive index adjustment layer has a textured surface. The textured surface of the refractive index adjustment layer is formed by the protrusions and recesses of the electrode having the textured surfaces. The refractive index adjustment layer is in contact with the electrode having the textured surfaces. A specific implementation of the refractive index adjustment layer may be the same as that described with reference to FIG. 1.

The structure in which the textured layer is in contact with the refractive index adjustment layer such as that in FIG. 1 is defined as a direct protrusion-recess-formation structure. The structure in which the electrode is present between the textured layer and the refractive index adjustment layer such as that in FIG. 2 is defined as an indirect protrusion-recess-formation structure. In this way, the textured interface is formed in contact with the refractive index adjustment layer, and thus the distribution of light can be controlled. The direct protrusion-recess-formation structure has the advantage that the textured surface can be more easily formed than in the indirect protrusion-recess-formation structure. In the direct protrusion-recess-formation structure, however, the textured layer is required to be configured so that an electric current flows between the pair of electrodes. In contrast, the indirect protrusion-recess-formation structure has the advantage that it is more easily ensured than with the direct protrusion-recess-formation structure that an electric current flows between the pair of electrodes. Furthermore, in the indirect protrusion-recess-formation structure, the electrode having the textured surfaces is separated from the substrate, and thus the difference in the refractive index between these layers has less impact. In the indirect protrusion-recess-formation structure, however, the electrode is required to be formed into a shape following the shape of the textured layer. Although optical device 1 having the direct protrusion-recess-formation structure exemplified by that in FIG. 1 will be mainly described below, the description below may also be applied to the indirect protrusion-recess-formation structure.

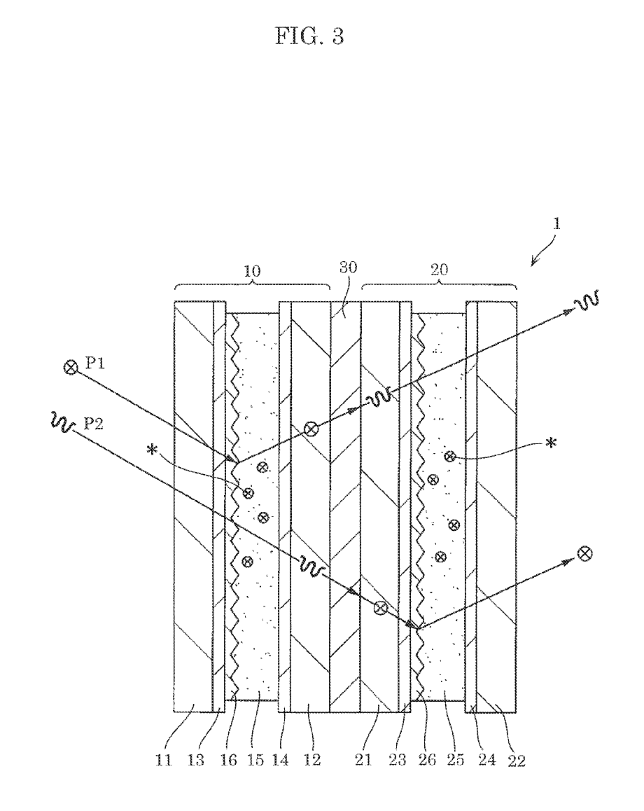

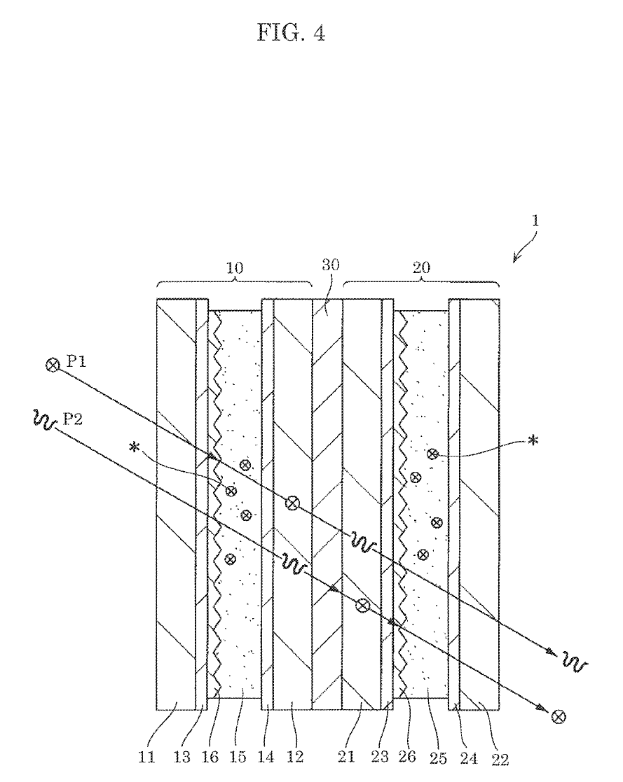

The effect (light distribution mechanism) of optical device 1 will be described with reference to FIG. 3 and FIG. 4. FIG. 3 illustrates the light distribution state, and FIG. 4 illustrates the non-light distribution state (the transparent state). In FIG. 3 and FIG. 4, optical device 1 is vertically provided like a window. Optical device 1 transitions at least between the light distribution state illustrated in FIG. 3 and the non-light distribution state (the transparent state) illustrated in FIG. 4.

FIG. 4 illustrates the traveling light when optical device 1 is in the transparent state. Light is indicated by arrows. Light may travel obliquely with respect to a direction perpendicular to the surface of optical device 1 (the same direction as the thickness direction). Especially when optical device 1 is a window, light is likely to be incident at an angle. Light passing through optical device 1 in the transparent state travels straight ahead. For example, when light from outside (outside light) is incident on optical device 1, the outside light remains in its original direction upon entering the inside.

Optical device 1 is placed into the transparent state as a result of matching between the refractive index of the refractive index adjustment layer and the refractive index of a layer that is in contact with the refractive index adjustment layer at the textured interface. The layer that is in contact with the refractive index adjustment layer at the textured interface is defined as a textured-interface adjacent layer. As illustrated in FIG. 4, the textured-interface adjacent layer is the textured layer (first textured layer 16 and second textured layer 26) in the case of the direct protrusion-recess-formation structure. FIG. 2 shows that the textured-interface adjacent layer is the electrode in contact with the refractive index adjustment layer in the case of the indirect protrusion-recess-formation structure. As the difference in the refractive index between the textured-interface adjacent layer and the refractive index adjustment layer decreases, the change in the direction of travel of light due to the difference in the refractive index decreases. When the difference in the refractive index between the textured-interface adjacent layer and the refractive index adjustment layer is eliminated or becomes negligible, a change in the travel of light due to the difference in the refractive index rarely occurs, and a change in the travel of light at the textured interface also rarely occurs. Thus, the direction of travel of light is maintained when the light passes through the textured interface.

In FIG. 4, the refractive index of first textured layer 16 and the refractive index of first refractive index adjustment layer 15 match, and the refractive index of second textured layer 26 and the refractive index of second refractive index adjustment layer 25 match. Therefore, changes in the direction of travel of light due to the protrusions and recesses and a difference in the refractive index do not occur at the textured interfaces between these layers. Thus, the incident light passes through optical device 1 without any changes in the direction of travel. Here, the incident light contains components of light (P1 and P2 in FIG. 4) having different directions of vibration, and the directions of travel of these components of light do not change regardless of the directions of vibrations.

Optical device 1 is placed into the transparent state, for example, through application of a voltage. The orientations of substances in the refractive index adjustment layer are aligned through the application of a voltage so that the difference in the refractive index between the textured-interface adjacent layer and the refractive index adjustment layer is reduced, and thus the transparency can be obtained. Optical device 1 is in the light distribution state, for example, when no voltage is applied. The optical state after the voltage is changed may be maintained. The properties that allow the optical state to be maintained are called hysteresis. These properties may be called storage properties (memory properties).

FIG. 3 illustrates the traveling light when optical device 1 is in the light distribution state. Light is indicated by arrows. The direction of travel of light incident on optical device 1 in the light distribution state is changed inside optical device 1. The direction of travel of the light may be changed at the interface between the textured layer and the refractive index adjustment layer. Optical device 1 may change the direction of travel of light into a target direction. Thus, light can be distributed in optical device 1. In the illustration in FIG. 3, the light that has traveled downward at an angle with respect to the surface of the ground passes through optical device 1 and then travels upward at an angle with respect to the surface of the ground. When light is bent in this way, the light is more likely to reach a distant location, and thus optical device 1 having better optical properties can be obtained.

Optical device 1 is placed into the light distribution state due to mismatching between the refractive index of the refractive index adjustment layer and the refractive index of the textured-interface adjacent layer (the textured layer in FIG. 3). When the difference in the refractive index between the textured-interface adjacent layer and the refractive index adjustment layer is large, the direction of travel of light is likely to change due to the difference in the refractive index, and furthermore, a change in the direction of travel of the light at the textured interface is added, allowing a change in the direction of travel of the light so that the light is bent. And it is possible to cause the light to travel in a target direction by controlling the difference in the refractive index between the textured-interface adjacent layer and the refractive index adjustment layer. Although FIG. 3 schematically depicts the direction of travel of light that is bent in one direction, the light may travel in a diffused manner. The light may be distributed in such a way that the amount of light in a target direction among the components of light increases. When the amount of light in a specific direction increases, the optical properties improve.

In FIG. 3, the refractive index of first textured layer 16 and the refractive index of first refractive index adjustment layer 15 do not match, and the refractive index of second textured layer 26 and the refractive index of second refractive index adjustment layer 25 do not match. Therefore, a change in the direction of travel of light due to the protrusions and recesses and the difference in the refractive index may occur at the textured interfaces between these layers. Here, the incident light contains components of light (P1 and P2 in FIG. 3) having different directions of vibration, and these components of light may include a component whose direction of travel changes according to its direction of vibration and a component whose direction of travel does not change regardless of its directions of vibration. This is because each of first refractive index adjustment layer 15 and second refractive index adjustment layer 25 has refractive index anisotropy. For this reason, two optical adjusters are stacked in the present embodiment. This allows both of the components of light having different directions of vibration to be distributed and increases the number of components of light that are distributed, and thus it is possible to improve the light distribution properties of optical device 1.

FIG. 3 illustrates, in a simplified manner, the direction of vibration of light divided into component P1 of light having a direction of vibration perpendicular to the plane defined by the sheet of the drawing and component P2 of light having a direction of vibration perpendicular to that of component P1. The arrows in the illustration indicate travel of light of components P1 and P2. The direction of vibration of component P1 is indicated by the circled X sign. The direction of vibration of component P2 is indicated by the wave sign. The direction of vibration of component P1 is defined as a first direction of vibration, and the direction of vibration of component P2 is defined as a second direction of vibration. The orientation of liquid crystal molecules in the refractive index adjustment layer (first refractive index adjustment layer 15 and second refractive index adjustment layer 25) is perpendicular to the plane defined by the sheet of the drawing, as is the case of component P1. The orientation (*) of liquid crystal molecules is indicated by the circled X sign.

In the present embodiment, when light that vibrates in the direction in which the liquid crystal molecules are oriented enters first refractive index adjustment layer 15 or second refractive index adjustment layer 25, the refractive index for the incident light is a large ordinary refractive index. When light that vibrates perpendicularly to the direction in which the liquid crystal molecules are oriented enters first refractive index adjustment layer 15 or second refractive index adjustment layer 25, the refractive index for the incident light is a small ordinary refractive index.

The direction of travel of component P1 of light is changed on the textured interface (the interface between first textured layer 16 and first refractive index adjustment layer 15) inside first optical adjuster 10. This is because the direction of vibration of component P1 and the orientation of the liquid crystal molecules are the same, meaning that there is a difference in refractive index at the textured interface, and thus light is more likely to be bent. In contrast, the direction of travel of component P2 of light is not changed on the textured interface (the interface between first textured layer 16 and first refractive index adjustment layer 15) inside first optical adjuster 10. This is because the direction of vibration of component P2 and the orientation of the liquid crystal molecules are not the same, meaning that the difference in refractive index at the textured interface is small, and thus light is less likely to be bent. In this way, the direction of travel of component P1 of incident light changes. Next, light that has passed through first optical adjuster 10 enters phase modulation layer 30. Phase modulation layer 30 shifts the phase of the incident light. The phase is preferably shifted by (½)λ where λ is the wavelength of the light, that is, by half the wavelength, through phase modulation layer 30. This causes a change in the direction of vibration of each of components P1 and P2 of light, as illustrated in FIG. 3. Specifically, the first direction of vibration changes to the second direction of vibration, and the second direction of vibration changes to the first direction of vibration. Component P1 after passing through phase modulation layer 30 vibrates in the second direction of vibration, and component P2 after passing through phase modulation layer 30 vibrates in the first direction of vibration. The light whose direction of vibration has changed enters second optical adjuster 20. Here, the textured interface (the interface between second textured layer 26 and second refractive index adjustment layer 25) in second optical adjuster 20 changes the direction of travel of component P2 of light because the direction of vibration of component P2 has changed to the first direction of vibration by phase modulation. In contrast, the textured interface in second optical adjuster 20 does not change the direction of travel of component P1 of light because the direction of vibration of component P1 has changed to the second direction of vibration by phase modulation. Thus, the direction of travel of component P2 of light changes in second optical adjuster 20. In this way, the directions of travel of both components P1 and P2 of light having passed through optical device 1 have consequently changed, meaning that the directions of travel of light having different directions of vibration change. Therefore, components of light that are not distributed depending on the direction of vibration of the light are reduced, and thus the light distribution properties of optical device 1 improve.

Note that the wavelength of light means a wavelength in the visible light region. Wavelength A may be considered to be 550 nm.

Stacking two optical adjusters as described above is particularly effective in the case where the refractive index adjustment layer contains liquid crystals. This is because liquid crystals have an orientational order and there are cases where liquid crystals may be or may not be able to change the direction of travel of light depending on the orientation of the liquid crystals. Particularly, in the case where the refractive index adjustment layer has refractive index anisotropy, it is possible to effectively change the direction of travel of light. Furthermore, when first refractive index adjustment layer 15 and second refractive index adjustment layer 25 have the same refractive index anisotropy, and phase modulation layer 30 is present between these layers, it is possible to efficiently and effectively change the direction of travel of light.

In optical device 1, light may be scattered at the refractive index adjustment layer. The light scattering properties in this case are the properties of light that can be scattered while the light distribution properties thereof are maintained. When the light scattering properties are provided, the glare of light can be reduced.

Optical device 1 can be fitted to a wall, etc., of a building, as illustrated in FIG. 3 and FIG. 4. The outside of a building is an outdoor area, and the inside of a building is an indoor area. Optical device 1 can function as a window.

As illustrated in FIG. 4, outside light enters the indoor area through optical device 1 in the state in which optical device 1 is transparent. The outside light is usually sunlight. Optical device 1 is in an optical state similar to, for example, the optical state of a glass window. At this time, the indoor area becomes bright with incident light, but, for example, in the case where the indoor area is large in depth, the indoor area is not likely to become entirely bright. Therefore, in a building having a glass window, a luminaire is often ON to illuminate the indoor area even during daytime.

In the state in FIG. 3, optical device 1 has light distribution properties. In this case, optical device 1 can change the direction of travel of light and distribute the light so that light traveling in a direction in which traveling light is likely to reach a deep part of the indoor area is generated or increased. In FIG. 3, light is changed to a direction toward the ceiling. The light traveling obliquely downward becomes light traveling obliquely upward by passing through optical device 1. Note that since the light distribution occurs not completely, but partially, there may be light bent toward the ceiling and light traveling straight ahead. At this time, the main component of light is preferably light bent by the light distribution. When light is distributed as illustrated in FIG. 3, light reaches an inward part of the indoor area, and thus even a deep part (a location far from optical device 1) of the indoor area becomes bright. Accordingly, the luminaire can be OFF or the power consumption of the luminaire can be reduced, meaning that energy can be saved.

The optical device may further include a pair of glass panels and have a structure in which the two optical adjusters described above are incorporated between the pair of glass panels. In this case, the optical device is configured as a glass panel unit (what is called double glazing). The optical adjusters are positioned in a sealed space provided between the pair of glass panels. The sealed space may be formed by sealing and bonding the pair of glass panels at the outer edges. The sealed space may be vacuum or may be filled with a gas such as an inert gas. When the glass panel unit is used for the optical device as just described, it is possible to improve the thermal insulation properties. Therefore, it is possible to obtain an optical device that is effective as a building material (including a window). Furthermore, the glass panel unit can protect the optical adjusters, and thus it is possible to improve mechanical strength. Consequently, it is possible to obtain an optical device that is not prone to breakage.

The optical device includes further variations. For example, among the plurality of substrates, the substrate provided inside the optical device may be removed. Specifically, in optical device 1 in FIG. 1, one or both of first counter substrate 12 and second substrate 21 may be omitted. In this case, first counter electrode 14 and phase modulation layer 30 may be in contact, and second electrode 23 and phase modulation layer 30 may be in contact. Furthermore, phase modulation layer 30 described above may be removed from optical device 1. In this case, the liquid crystals of first refractive index adjustment layer 15 and the liquid crystals of second refractive index adjustment layer 25 may have different orientations. Accordingly the two refractive index adjustment layers have optically different anisotropies and thus can distribute light having different directions of vibration, leading to an improvement in the light distribution properties of optical device 1. Furthermore, three or more optical adjusters may be provided. Furthermore, in the case where optical device 1 is incorporated in a pair of glass panels, a part of the glass panels may form a substrate. Optical devices 1 in these variations also have good light distribution properties.

### Other Variations

Although the optical device according to the present invention has been described based on the above embodiment and variations thereof, the present invention is not limited to the above embodiment.

Aside from the above, forms obtained by various modifications to the above-described embodiment that can be conceived by a person skilled in the art as well as forms realized by arbitrarily combining structural elements and functions in the embodiment which are within the scope of the essence of the present invention are included in the present invention.

### REFERENCE MARKS IN THE DRAWINGS

1 optical device
10 first optical adjuster
11 first substrate
12 first counter substrate
13 first electrode
14 first counter electrode
15 first refractive index adjustment layer
16 first textured layer
20 second optical adjuster
21 second substrate
22 second counter substrate
23 second electrode
24 second counter electrode
25 second refractive index adjustment layer
26 second textured layer
30 phase modulation layer

1. An optical device, comprising:
a first optical adjuster;
a second optical adjuster; and
a phase modulation layer provided between the first optical adjuster and the second optical adjuster,
wherein the first optical adjuster includes:
a first electrode that is light-transmissive;
a first counter electrode that is light-transmissive and is electrically paired with the first electrode;
a first refractive index adjustment layer that is provided between the first electrode and the first counter electrode, contains liquid crystals, has a refractive index changing in response to an electric field, is changeable between a transparent state and a state in which the first refractive index adjustment layer distributes incident light, according to a change in the refractive index, and has refractive index anisotropy; and
a first textured layer that gives the first refractive index adjustment layer an uneven surface,
the second optical adjuster includes:
a second electrode that is light-transmissive;
a second counter electrode that is light-transmissive and is electrically paired with the second electrode;
a second refractive index adjustment layer that is provided between the second electrode and the second counter electrode, contains liquid crystals, has a refractive index changing in response to the electric field, is changeable between the transparent state and a state in which the second refractive index adjustment layer distributes incident light, according to a change in the refractive index, and has refractive index anisotropy; and
a second textured layer that gives the second refractive index adjustment layer an uneven surface,
each of the first textured layer and the second textured layer includes a protrusion having one of a triangular cross-section and a trapezoidal cross-section and having a side surface oblique to a thickness direction of the protrusion, and
the first optical adjuster and the second optical adjuster are arranged in a thickness direction of the optical device.

2. The optical device according to claim 1,
wherein the phase modulation layer shifts a phase of incident light having a wavelength λ by (½)λ.

3. The optical device according to claim 1,
wherein the first textured layer and the second textured layer are identical in structure.

4. The optical device according to claim 1,
wherein the first optical adjuster and the second optical adjuster are identical in structure.
